(19) United States
(12) Patent Application Publication
(10) Pub. No.: US 2010/0204992 A1
(43) Pub. Date: Aug. 12, 2010

(54) METHOD FOR INDENTIFYING AN ACOUSIC EVENT IN AN AUDIO SIGNAL

(76) Inventor: Markus Schlosser, Hannover (DE)

Correspondence Address: Robert D. Shedd, Patent Operations;THOMSON Licensing LLC, P.O. Box 5312, Princeton, NJ, 08543-5312, US

(21) Appl. No.: 12/733,334

(22) PCT Filed: Aug. 25, 2008
(86) PCT No.: PCT/EP2008/061075

§ 371 Date: Feb. 24, 2010

(30) Foreign Application Priority Data
Aug. 31, 2007 (EP) 07115473.6

(51) Int. Cl. G10L 15/00; G06F 19/00

(52) U.S. Cl. 704/246; 704/231; 702/70; 704/E15.001

(57) ABSTRACT

An process for recognizing an acoustic event in an audio signal has two stages The first stage involves possible candidates being selected, and the second stage involves each of the possible candidates being allocated a confidence value.

The invention relates to a method for recognizing an acoustic event in an audio signal.

There are many applications in which it is necessary to recognize an acoustic event in an audio signal. One example is recognizing a clack for synchronizing audio and video signals. The audio signal of a clack, as precursive signal, is one of the transient signals. It is necessary to synchronize audio and video signals when producing and transmitting films, inter alia, for example for messages which should be available as quickly as possible.

A method for recognizing acoustic events in audio signals is described in EP 1 465 192 A1. The method comprises a stage which involves the use of an arbitrary combination of different steps for classifying the audio signal as: recognized event or no event recognized. The selected steps for the classification are performed on the entire, possibly processed audio signal.

Further methods for recognizing acoustic events are known from U.S. Pat. No. 5,884,260 and from US 2005/0199064 A1, for example.

It is an object of the invention to develop a method for recognizing an acoustic event which allows rapid recognition of the event.

The object is achieved by the features of Claim 1. Advantageous embodiments of the invention are described in the subclaims.

An inventive method for recognizing an acoustic event in an audio signal, e.g. in a wav file, has two stages. The first stage involves possible candidates being selected, and the second stage involves each of the possible candidates being allocated a confidence value.

Splitting the recognition method into two stages, namely first of all a first selection of possible candidates in the first stage and then a more precise check on the possible candidates in the second stage, allows a significant reduction in the amount of data which is to be evaluated in comparison with methods in which the candidates are checked without preselection.

The confidence value is a measure of the probability of it being the sought event. The allocation of a confidence value to each possible candidate allows an operator, when determining the final candidates, to spot the possible candidates with the highest confidence values first of all and to end the search as soon as the sought candidates have been found. It is possible to disregard possible, incorrect candidates with similar properties to the sought events, i.e. with admittedly high but somewhat lower confidence values than the sought events.

For the selection of the possible candidates, the first stage has the following steps in line with the invention: a first high-pass filter is applied to the audio signal, said high-pass filter having a wide transition band, so that higher frequencies have a higher weighting, a first energy envelope is calculated in the time domain from the filtered audio signal, a derivation is calculated from the energy envelope, and

possible candidates are determined from events for which the derivation of the energy envelope is above a predetermined threshold value. This is a simple method for selecting the possible candidates.

In line with the invention, the second stage has the following steps for each possible candidate: a plurality of variables: for the possible candidate are evaluated, and a common confidence value is allocated using an assessment of the variables.

In line with the invention, the second stage has the following steps for each possible candidate for evaluating the variables:

a second high-pass filter is applied to the audio signal, said high-pass filter having a lower cut-off frequency than the first high-pass filter, in order to reject noise at a low frequency, and

a second energy envelope is calculated in the time domain from the filtered audio signal.

In this context, the invention involves the following variables for each possible candidate being evaluated:
energy increase, i.e. the maximum value of the derivation of the first energy envelope, and
level and position of the measured maximum from the second energy envelope.

The second stage preferably involves one or more of the following variables for each possible candidate being evaluated:
energy increase, i.e. the maximum value of the derivation,
level and position of the measured maximum,
gradient and error of a curve matched to the energy drop in the energy envelope,
difference between a measured maximum and a maximum predicted from the curve,
duration of the possible candidate,
duration of a silent period before the possible candidate and duration of a silent period after the possible candidate, and
time at which the possible candidate appears.

Preferably, the second stage has the following step for each possible candidate for evaluating the variables:

a noise range in the audio signal is determined.

In one embodiment of the invention, the determination of the noise range comprises determination of an ambient noise level and/or a recording level. Preferably, this involves the use of the energy envelope calculated in the second stage.

Preferably, the second stage has the following respective steps for each possible candidate for assessing one or more of the evaluated variables: a probability ratio and/or a weighting factor is/are determined. Preferably, the probability ratios and/or the weighting factors of the evaluated variables are combined during the allocation of the common confidence value.

In one embodiment of the invention, the allocation of the common confidence value involves addition of logarithms of the probability ratios, weighted by the weighting factors, of the selected variables.

Preferably, the weighting factors of one or more of the evaluated variables are respectively calculated from correlation coefficients for paired correlations of the evaluated variables.

Preferably, the determination of the probability ratios takes account of one or more supplementary information items about the acoustic event.

In one embodiment of the invention, the second stage alternatively or additionally has the following step for each possible candidate: a text referring to the acoustic event is subjected to voice recognition.

The inventive method is preferably used for recognizing clacks during the synchronization of the audio signal to an appropriate video signal.

The invention is explained further with reference to an example which is shown schematically in the drawing, in which:

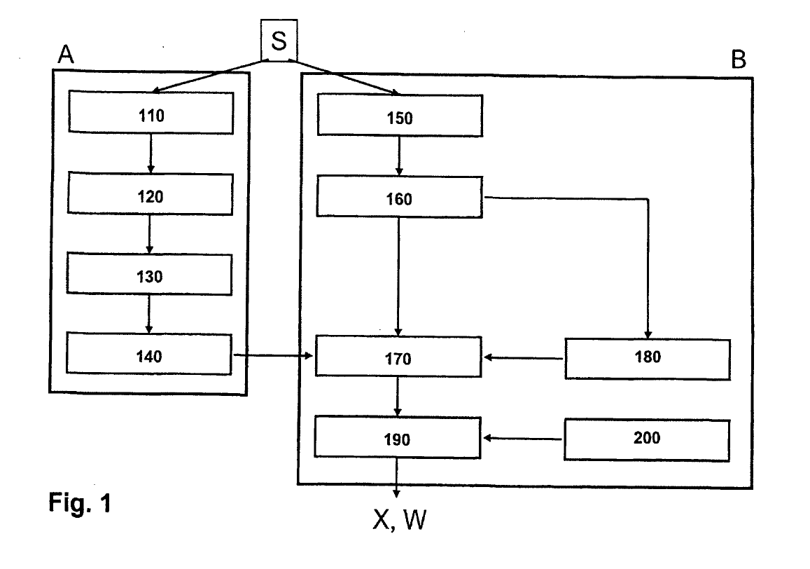

FIG. 1 shows a block diagram of an example based on the invention, and

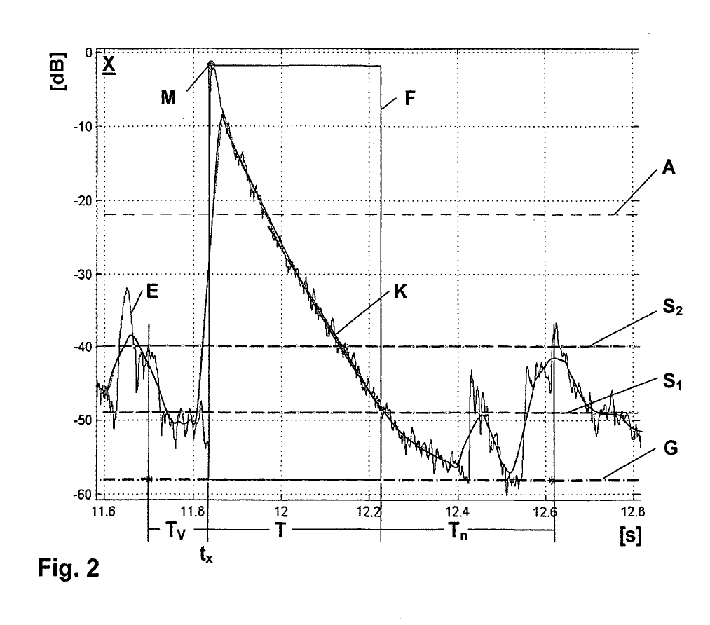

FIG. 2 shows an illustration of a possible candidate in the time domain with evaluated variables which shows an appropriate detail from the audio signal using the energy in decibels dB over the time in seconds s.

An inventive method for recognizing an acoustic event in an audio signal S, specifically in this example for recognizing a clack, has two stages A, B. The first stage A involves possible candidates X being selected, and the second stage B involves each of the possible candidates X being allocated a confidence value W. The audio signal is a wav file, for example, which is processed by a program which carries out the method according to the invention.

To select the possible candidate X, the first stage A of the inventive method has the following steps shown in FIG. 1: a first high-pass filter is applied 110 to the audio signal S, an energy envelope is calculated 120 in the time domain from the filtered audio signal S, a derivation is calculated 130 from the energy envelope, and possible candidates are determined 140 from events for which the maximum value of the derivation is above a predetermined threshold value. The derivation is a measure of the energy increase.

The first high-pass filter is designed to have a very shallow edge, i.e. it has a wide transition band of frequencies between 2000 and 3000 Hz, for example. In this case, frequencies are allowed to pass all the better the higher they are, which means that higher frequencies have a higher weighting. Another advantage of this high-pass filter is that a filter with such a shallow edge can be achieved with a low filter order and hence with a low level of computation complexity.

In the audio signal S, the maximum value of the derivation for a possible candidate X is above a particular threshold value. The threshold value is chosen on the basis of the event which is to be recognized. In this example for the recognition of clacks, the threshold value may be 18 dB, for example.

Since a clack event should be situated within an accuracy of one quarter frame, i.e. in the range of 10 ms at 25 frames per second, the energy envelope is calculated using a rectangular window F of 5 ms. This practice is based on a low-pass filter and is suitable for rejecting noise.

FIG. 2 shows a possible candidate X found in the first stage A. The rectangular window F is shown in FIG. 2.

The second stage B has the following steps, shown in FIG. 1, for each possible candidate X:

a second high-pass filter is applied 150 to the audio signal S,

a second energy envelope E is calculated 160 in a time domain from the filtered audio signal S,

one or more variables are evaluated 170 using the calculation 160 of the energy envelope E and using a determination 180 of a noise range in the filtered audio signal S, and

a common confidence value W is allocated 190 using an assessment 200 of the variables.

The confidence value W is a measure of the probability of it being the sought event. As a relative measure compared with confidence values W for further possible candidates X in an audio signal, the confidence value W allows the correct candidate to be found quickly.

The variables for a possible candidate X are additionally evaluated 180 using the maximum value for the derivation, i.e. for the energy increase, which was ascertained in the first stage A.

The second high-pass filter, which is applied to the original audio signal S, has a cut-off frequency of 200 Hz, for example. It is used in order to reject noise at a low frequency, such as a 50-Hz or 60-Hz hum or mechanical noises from a running camera.

The determination 180 of the noise range comprises determination of an ambient noise level G and/or of a recording level A for the audio signal S. For determining the ambient noise level G and for determining the recording level A, the energy envelope E calculated in the second stage B is used, with a histogram of values of the energy envelope E being created. The recording level A defined is the value which is exceeded by only 1% of the values, for example, and the ambient noise level defined is the value which is not exceeded by 5% of the values.

Outliers with very little energy, e.g. as a result of switching on a microphone, are not taken into account in this method. In addition, the recording level A needs to be ascertained from longer signal sections than the ambient noise level G.

The second stage B involves one or more of the following variables being evaluated 170 for each possible candidate:
energy increase, i.e. the maximum value of the derivation,
level and position of the measured maximum M,
gradient and error of a curve K matched to the energy drop in the envelope,
difference between a measured maximum M and a maximum predicted from the curve K,
duration T of the possible candidate X,
duration Tᵥ of a silent period before the possible candidate X and duration Tₙ of a silent period after the possible candidate X, and
time tₓ at which the possible candidate X appears.

The energy increase is the only variable which is ascertained in the first stage A and which is calculated from the energy envelope of the audio signal S filtered by the first high-pass filter. All other variables are derived from the energy envelope E of the audio signal S filtered by the second high-pass filter, which cuts off only low frequencies, said energy envelope being ascertained in the second stage B.

When evaluating the measured maximum M, the level thereof for the maximum M involves ascertainment of the difference between the measured maximum and the recording level A. In addition, the position of said maximum is established. A maximum which is found is replaced by an earlier local maximum if it is presumed to be produced by reflections. To this end, the maximum is determined in two different time intervals, in a relatively short time interval and in a relatively long time interval. The maximum in the relatively long time interval needs to be significantly higher in order to be accepted as a real maximum.

The gradient and error of a curve K matched to the energy drop in the envelope are evaluated. This evaluation takes account of the fact that the energy drop in the clack event drops exponentially as a result of the reflections in the room, i.e. on the walls, on the floor and on the ceiling. The curve is matched using logarithmic scaling, so that it is easily matched to a linear drop. In addition, this matching allows the quality of the matching to be established by means of the mean square error.

An exponential energy drop appears for the energy envelope E normally only at the back of the progression as a result of later diffuse reflections in what is known as reverberation. In the initial region, rather discrete reflections affect the drop. The curve matching is therefore limited to the back portion of the acoustic event. The curve matching involves measured values being weighted on the basis of the distance thereof from the ambient noise level G, since values with low energy, i.e. close to the ambient noise level G, are influenced to a greater extent by background noise. The curve matching is provided with a low assessment if the audio signal S is presumed to have been recorded outdoors, i.e. if it is short and there are only discrete reflections and barely any reverberation present. This is done by using the duration of the possible candidate X and a sigmoid weighting function.

The energy drop may be interrupted by simultaneous background noise or other foreground noise. In this case, curve matching is performed only up to this interruption. To recognize an interruption, an additional low-pass filter is applied to the energy envelope E. An interruption in the energy drop is detected if this filtered energy envelope rises again before the original energy envelope E reaches a lower silence threshold value S₁. Upon detection of an interruption in the energy drop, the confidence value W for the possible candidate X is reduced directly or indirectly on the basis of the distance between the interruption and a lower silence threshold value S₁.

The difference between a measured maximum M and a maximum predicted from the curve K is ascertained using logarithmic scaling. It is therefore a relative difference.

The duration T of the possible candidate X, i.e. of the acoustic event, is ascertained from the period of time in which the energy, i.e. the energy envelope E, is above the lower silence threshold value S₁.

The duration Tᵥ of a silent period before the acoustic event, i.e. before the possible candidate X, and the duration Tₙ of a silent period after the possible candidate X are periods of time which the energy envelope E needs in order to get above an upper silence threshold value S₂ after it has fallen below the lower silence threshold value S₁. This hysteresis prevents soft noise from being recognized as the end of a silent period. For a proper clack, the silent periods Tᵥ and Tₙ are neither too long nor too short. If the closing movement itself causes noise, there is possibly no silent period Tᵥ before the clack. This is taken into account for the evaluation. For outdoor recordings, echoes are ignored, as far as possible, when evaluating the silent periods Tᵥ and Tₙ.

When evaluating the time Tₓ at which the possible candidate appears, it is borne in mind that a possible candidate, namely a clack, is typically found at the start or at the end of a recording.

The second stage B comprises the following steps, for each variable, for assessing 200 the evaluated variable described above: a probability ratio v and/or a weighting factor w is/are determined.

When a common confidence value W is allocated 190 to a possible candidate, the probability ratios v and/or the weighting factors w of the evaluated variables are combined. This is done by adding the logarithms of the probability ratios v, weighted by the weighting factors w, of the selected variables. The weighting factors w of the evaluated variables are respectively calculated from correlation coefficients k for paired correlations of the evaluated variables.

In particular, for N evaluated variables, the weighting factor wi of a variable i is calculated from the correlation coefficients kij for the N paired correlations as follows:

$${W}_{i} = \frac{1}{{\sum }_{j} {\vert k i j \vert}^{m}} , j = 1 to N$$

The correlation coefficient kij is a measure of the correlation between the i-th and j-th variables and is ascertained from empirical data. When calculating the correlation coefficients kij, outliers exceeding a 3σ limit are rejected. The exponent m determines the extent to which the correlation is considered. The higher the exponent m, the lesser the extent to which the influence of a possible correlation is taken into account. It should be chosen to be higher if only a few data items for gauging the correlation coefficients are present.

In one alternative embodiment of the invention, the determination of the probability ratios v takes account of one or more additional information items about the acoustic event. Such additional information items are the following information about the audio signal S, for example:

separate recordings with starting clacks or ending clacks, solo clacks, or

indoor recordings or outdoor recordings.

In a further alternative embodiment of the invention, the second stage B alternatively or additionally comprises the following step for each possible candidate X:

a text referring to the acoustic event is subjected to voice recognition.

1. A process for recognizing an acoustic event in an audio signal, wherein in a first stage possible candidates are selected, said first stage comprising the following steps:
applying a first high-pass filter to the audio signal, said high-pass filter having a wide transition band, so that higher frequencies have a higher weighting,
calculating an energy envelope in the time domain from the filtered audio signal,
calculating a derivative from the energy envelope, and
determining possible candidates from events for which the maximum value of the derivative is above a predetermined threshold value,
and wherein in a second stage each of the possible candidates is allocated a confidence value, wherein the second stage comprises the following steps for each possible candidate:
evaluating a plurality of variables, and
allocating a common confidence value using an assessment of the variables,
wherein the second stage comprises the following steps for each possible candidate for evaluating the variables:
applying a second high-pass filter to the audio signal, said high-pass filter having a lower cut-off frequency than the first high-pass filter in order to reject noise at a low frequency, and
calculating an energy envelope in the time domain from the filtered audio signal,
wherein the following variables are evaluated:
energy increase, i.e. the maximum value of the derivative of the first energy envelope, and
level and position of the measured maximum from the second energy envelope.

2. The process of claim 1, wherein, in the second stage, one or more of the following variables are evaluated for each possible candidate:
gradient and error of a curve matched to the energy decay of the envelope,
difference between a measured maximum and a maximum predicted from the curve,
duration of the possible candidate,
duration of a silent period before the possible candidate and duration of a silent period after the possible candidate, and
time at which the possible candidate appears.

3. The process of claim 2, wherein the second stage comprises the following step for each possible candidate for evaluating the variables:
Determining a noise range in the audio signal.

4. The process of claim 3, wherein the determination of the noise range comprises determination of an ambient noise level and/or a recording level.

5. The process of claim 3, wherein the determination of the noise range involves use of the energy envelope calculated in the second stage.

6. The process of claim 1 wherein the second stage has the following respective steps for each possible candidate for assessing ) one or more of the evaluated variables:
Determining a probability ratio and/or a weighting factor.

7. The process of claim 6, wherein the allocation of a common confidence value involves the probability ratios and/or the weighting factors of the evaluated variables being combined.

8. The process of claim 7, wherein the allocation of a common confidence value involves addition of logarithms of the probability ratios, weighted by the weighting factors, of the selected variables.

9. The process of claim 6, wherein the weighting factors of one or more of the evaluated variables are respectively calculated from correlation coefficients for paired correlations of the evaluated variables.

10. The process of claim 6, wherein the determination of the probability ratios takes account of one or more supplementary information items about the acoustic event.

11. The process of claim 1, wherein the second stage alternatively or additionally has the following step for each possible candidate:
a text referring to the acoustic event is subjected to voice recognition.

12. The process of claim 1, wherein the acoustic event corresponds to the sound of clapperboards used for the synchronization of the audio signal to an appropriate video signal.
